(19) United States
(12) Patent Application Publication
(10) Pub. No.: US 2004/0233514 A1
(43) Pub. Date: Nov. 25, 2004

(54) Fluorescent glass, optical amplification waveguide and optical amplification module

(76) Inventors: Masahiro Takagi, Yokohama-skhi (JP); Tetsuya Haruna, Yokohama-shi (JP); Motoki Kakui, Yokohama-shi (JP); Masayuki Shigematsu, Yokohama-shi (JP); Takahiro Murata, Onojo-shi (JP)

Correspondence Address: MCDERMOTT, WILL & EMERY, 600 13th Street, N.W., Washington, DC, 20005-3096, US

(21) Appl. No.: 10/779,860

(22) Filed: Feb. 18, 2004

(30) Foreign Application Priority Data
Feb. 18, 2003 (JP) P2003-040186

(51) Int. Cl. H01S 3/00

(52) U.S. Cl. 359/341.1

(57) ABSTRACT

The present invention relates to a fluorescent glass capable of being doped with a high concentration of rare earth ions and suitable for optical communication application, and an optical component incorporating it. The fluorescent glass comprises Al₂O₃ of 15 to 50 mol %; SiO₂ of 0 to 80 mol %; an oxide of 5 to 85 mol % in total comprising at least one of B₂O₃, Ga₂O₃, Y₂O₃, Ta₂O₅, Sb₂O₃, Nd₂O₅, La₂O₃, and Yb₂O₃; and a rare earth ion. Concentration quenching is more suppressed in this fluorescent glass than in conventional fluorescent glasses, and it is thus feasible for the fluorescent glass to be doped with a high concentration of rare earth ions and to highly efficiently generate fluorescence of wavelengths in the signal wavelength bands generally used in optical communication.

### BACKGROUND OF THE INVENTION

1. Field of the Invention

The present invention relates to a fluorescent glass possessing a fluorescence emitting property, an optical amplification waveguide having at least a part comprised of the fluorescent glass, and an optical amplification module incorporating the fluorescent glass or the optical amplification waveguide.

2. Related Background Art

An optical amplification module used in an optical communication system or the like is an optical component for compensating for a loss of signal light suffered during propagation on an optical transmission path. For example, in the case of an optical amplification module incorporating an optical amplification fiber as an optical amplification medium, when pumping light is supplied into the optical amplification fiber, signal light is amplified in the optical amplification fiber. The core region of the optical amplification fiber used in this case is comprised of a fluorescent glass obtained by doping a silica glass with rare earth ions.

For example, an optical amplification module having a silica-based optical amplification fiber doped with Er ions (EDF: Erbium Doped Fiber), as an optical amplification medium (EDFA: Erbium Doped Fiber Amplifier) can amplify the C-band (1530 nm to 1565 nm) or L-band (1565 nm to 1625 nm) signal light, using the 0.98 μm or 1.48 μm wavelength band pumping light.

A fluorescent glass disclosed in Japanese Patent Application Laid-Open No. 2000-159543 contains SiO₂, Al₂O₃, and B₂O₃ and further contains LnₓO_{y} (where Ln is an element selected from Y, Ce, Pr, Nd, etc.). The fluorescent glass emits fluorescence in the visible region under irradiation with ultraviolet light as pumping light.

### SUMMARY OF THE INVENTION

The Inventor investigated the above-mentioned prior art and found the following problems.

Namely, concentration quenching occurs in the EDF at high dopant concentrations of Er ions. The EDF fails to secure a sufficient width of an amplifiable wavelength band. Particularly, such EDF cannot amplify the signal light in the wavelength region of 1605 nm or more and it is virtually impossible for the EDF to amplify the signal light even in the wavelength region of 1525 nm or less.

The fluorescent glass disclosed in the aforementioned Japanese Patent Application Laid-Open No. 2000-159543 generates the fluorescence in the visible region, but the transmittance thereof is low in the signal wavelength bands generally used in optical communication. Therefore, even where the optical amplification fiber having at least a part comprised of this fluorescent glass is applied as an optical amplification medium, the optical amplification fiber cannot be used in optical communication application.

The present invention has been accomplished to solve the problems as described above and an object of the invention is to provide a fluorescent glass, an optical amplification waveguide, and an optical amplification module suitable for optical communication application, while enabling doping with a high concentration of rare earth ions.

A fluorescent glass according to the present invention comprises Al₂O₃ of 15 to 50 mol %; SiO₂ of 0 to 80 mol %; an oxide of 5 to 85 mol % in total comprising at least one of B₂O₃, Ga₂O₃, Y₂O₃, Ta₂O₅, Sb₂O₃, Nd₂O₅, La₂O₃, and Yb₂O₃; and a rare earth ion. The fluorescent glass according to the present invention embraces a fluorescent glass in which the content of SiO₂ is 0 mol %, i.e., a fluorescent glass without SiO₂. Since concentration quenching is more suppressed in the fluorescent glass according to the present invention than in the conventional fluorescent glasses, the fluorescent glass of the present invention can be doped with a high concentration of rare earth ions and efficiently generate fluorescence of wavelengths in the signal wavelength bands generally used in optical communication.

In the fluorescent glass according to the present invention, the oxide may comprise B₂O₃ of 5 to 85 mol %. In the fluorescent glass according to the present invention, the oxide may comprise at least one oxide of 5 to 85 mol % in total selected from Ga₂O₃, Y₂O₃, Ta₂O₅, Sb₂O₃, Nd₂O₅, La₂O₃, and Yb₂O₃, except the B₂O₃. The rare earth ion in the fluorescent glass of the present invention preferably comprises an Er ion in a weight proportion of 2000 wt.ppm or more.

An optical amplification waveguide according to the present invention comprises a core region in which signal light and pumping light propagates, and a cladding region provided on an outer periphery of the core region. At least a part of this core region comprises the aforementioned fluorescent glass, and the signal light is amplified in this core region under supply of the pumping light. In this manner, the optical amplification waveguide according to the present invention can be used as an optical amplification medium to amplify the signal light in an optical communication system.

In the optical amplification waveguide according to the present invention, the core region may comprise an inner core comprised of the fluorescent glass, and an outer core provided on an outer periphery of the inner core and comprised of a silica-based glass as a principal component. The optical amplification waveguide having this structure can highly efficiently amplify the signal light under supply of the pumping light, because the inner core where guided light has large energy is comprised of the aforementioned fluorescent glass. In this structure, the outer core preferably comprises at least one of Al₂O₃, GeO₂, P₂O₅, Cl, and F. In this case, degrees of freedom increase for formation of a refractive index profile in the entire core region.

Conversely, in the optical amplification waveguide according to the present invention, the core region may comprise an inner core comprised of a silica-based glass as a principal component, and an outer core provided on an outer periphery of the inner core and comprised of the fluorescent glass. The optical amplification waveguide having this structure can keep losses of the pumping light and signal light at a low level, because transparency is enhanced in the inner core where guided light has large energy. In this structure, the inner core preferably comprises at least one of Al₂O₃, GeO₂, P₂O₅, Cl, and F. In this case, degrees of freedom also increase for formation of a refractive index profile in the entire core region.

In the optical amplification waveguide according to the present invention, preferably, the cladding region provided on the outer periphery of the core region has a refractive index lower than that of the core region and has a melting point of 1400° C. or more. This facilitates a fusion splice with another silica-based optical fiber.

An optical amplification module according to the present invention preferably comprises a transmission medium having at least a part comprised of the aforementioned fluorescent glass, and a pumping light supply system for supplying pumping light into the transmission medium. Another optical amplification module according to the present invention may comprise the optical amplification waveguide having the structure as described above, and a pumping light supply system for supplying pumping light into the optical amplification waveguide. Since concentration quenching is effectively suppressed in the fluorescent glass or in the optical amplification waveguide used as an optical amplification medium, these optical amplification modules permit doping with a high concentration of rare earth ions and can highly efficiently optically amplify light in the signal wavelength bands generally used in optical communication.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a fluorescence spectrum of sample A of the fluorescent glass according to the present invention;

FIG. 2 is a fluorescence spectrum of sample B of the fluorescent glass according to the present invention;

FIG. 3 is a fluorescence spectrum of sample C of the fluorescent glass according to the present invention;

FIG. 4 is a perspective view showing a configuration of a first embodiment of the optical amplification waveguide according to the present invention;

FIG. 5 is a perspective view showing a configuration of a second embodiment of the optical amplification waveguide according to the present invention;

FIGS. 6A and 6B are a sectional view showing a configuration of a third embodiment of the optical amplification waveguide according to the present invention, and its refractive index profile;

FIGS. 7A and 7B are a sectional view showing a configuration of a fourth embodiment of the optical amplification waveguide according to the present invention, and its refractive index profile;

FIGS. 8A and 8B are a sectional view showing a configuration of a fifth embodiment of the optical amplification waveguide according to the present invention, and its refractive index profile; and

FIG. 9 is an illustration showing a configuration of an embodiment of the optical amplification module according to the present invention.

### DETAILED DESCRIPTION OF THE PREFERRED EMBODIMENTS

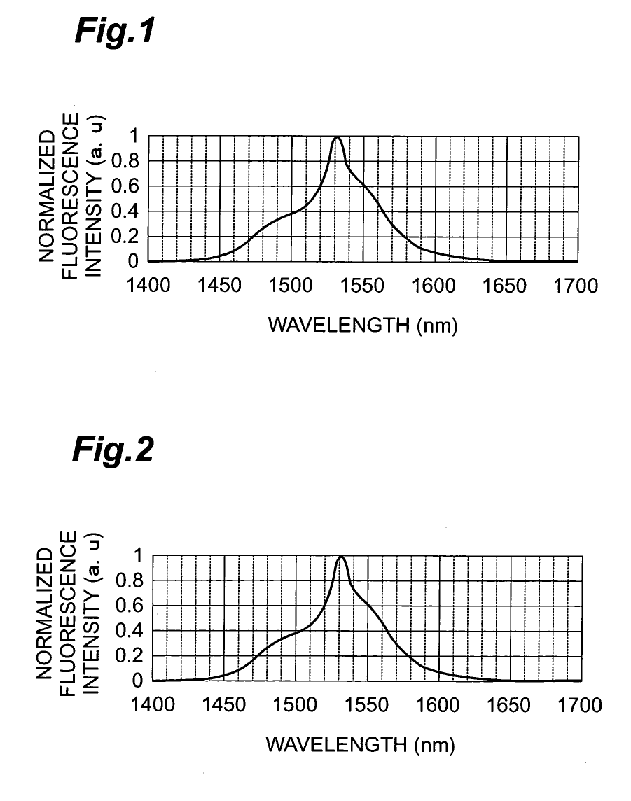

The embodiments of the fluorescent glass, the optical amplification waveguide, and the optical amplification module according to the present invention will be described below in detail with reference to FIGS. 1 to 5, 6A to 8B, and 9. The same elements will be denoted by the same reference symbols throughout the description of the drawings, without redundant description.

### Fluorescent Glass

First, an embodiment of the fluorescent glass according to the present invention will be described. The fluorescent glass of the present embodiment comprises Al₂O₃ of 15 to 50 mol %; SiO₂ of 0 to 80 mol %; an oxide of 5 to 85 mol % in total comprising at least one of B₂O₃, Ga₂O₃, Y₂O₃, Ta₂O₅, Sb₂O₃, Nd₂O₅, La₂O₃, and Yb₂O₃; and a rare earth ion. If the content of SiO₂ is too high, it will induce crystallization and vitrification will become very difficult. For this reason, the SiO₂ content is preferably 80 mol % or less and a more favorable range is preferably 50 mol % or less. Vitrification is possible even if the SiO₂ content is 0 mol %.

The Al₂O₃ content in the fluorescent glass needs to be 15 mol % or more, and is preferably 18 mol % or more and more preferably 20 mol % or more. On the other hand, when the Al₂O₃ content is too high, vitrification will become difficult. Therefore, the Al₂O₃ content needs to be 50 mol % or less.

The fluorescent glass may contain B₂O₃ as the aforementioned oxide and, in this case, the B₂O₃ content is preferably 5 mol % or more, more preferably 10 mol % or more, and still more preferably 15 mol % or more. On the other hand, when the B₂O₃ content is too high, the melting point of the fluorescent glass will decrease, and the refractive index of the fluorescent glass will be lowered. Therefore, the B₂O₃ content is preferably 85 mol % or less and more preferably 75 mol % or less.

The oxide in the fluorescent glass preferably comprises at least one oxide of 5 to 85 mol % in total selected from Ga₂O₃, Y₂O₃, Ta₂O₅, Sb₂O₃, Nd₂O₅, La₂O₃, and Yb₂O₃, except the above B₂O₃. The total content of the oxide is preferably 8 to 80 mol % and more preferably 10 to 80 mol %. In particular, inclusion of at least one of Ga₂O₃ and Ta₂O₅ in the fluorescent glass is effective in expansion of the bandwidth of the fluorescent wavelength region. When Y₂O₃ is included in the fluorescent glass, the mechanical strength of the fluorescent glass is effectively enhanced.

Furthermore, the rare earth ion in the fluorescent glass is preferably an ion of Pr, Nd, Tm, Dy, or Er. Specifically, it is preferable that the rare earth ion be an Er ion, in order to amplify the signal light in the wavelength band of 1500 nm to 1600 nm generally used in optical communication.

Clustering of Er ions is less likely to occur in the fluorescent glass of the present invention than in the conventional fluorescent glasses, so that concentration quenching is more suppressed. Therefore, the fluorescent glass of the present invention can be doped with a high concentration of rare earth ions and efficiently generate the fluorescence of wavelengths in the signal wavelength bands generally used in optical communication. The content of the rare earth ion in the fluorescent glass is preferably a weight proportion of 2000 wt.ppm or more and more preferably 2500 wt.ppm or more.

In particular, where the fluorescent glass is used as an optical amplification medium for amplifying the signal light of wavelengths of 1600 nm or more, this fluorescent glass (or an optical amplification waveguide comprised of this fluorescent glass) can have a shorter length necessary for achieving a required optical amplification gain, by increasing the Er ion content per unit length (e.g., 3000 wt.ppm or more). For this reason, the optical amplification waveguide comprised of the fluorescent glass (e.g., an optical amplification fiber) can be excellent in storageability and effectively suppress occurrence of nonlinear optical phenomena.

A plurality of samples A to C prepared as fluorescent glasses of the present invention will be described below along with sample D as a comparative example. The fluorescent glass of sample A contains Y₂O₃ of 16 mol %, Al₂O₃ of 25.6 mol %, SiO₂ of 38.1 mol %, B₂O₃ of 20 mol %, and Er³⁺ ion of 0.6 mol %. The fluorescent glass of sample B contains Y₂O₃ of 14 mol %, Al₂O₃ of 22.4 mol %, SiO₂ of 33.3 mol %, Ga₂O₃ of 15 mol %, Ta₂O₅ of 15 mol %, and Er³⁺ ion of 0.6 mol %. The fluorescent glass of sample C contains Y₂O₃ of 15 mol %, Al₂O₃ of 25 mol %, B₂O₃ of 59.7 mol %, and Er³⁺ ion of 0.6 mol %. Sample D of the comparative example contains Y₂O₃ of 25 mol %, Al₂O₃ of 15 mol %, B₂O₃ of 59.7 mol %, and Er³⁺ ion of 0.6 mol %. Each of these samples A to D was prepared by a fusion method.

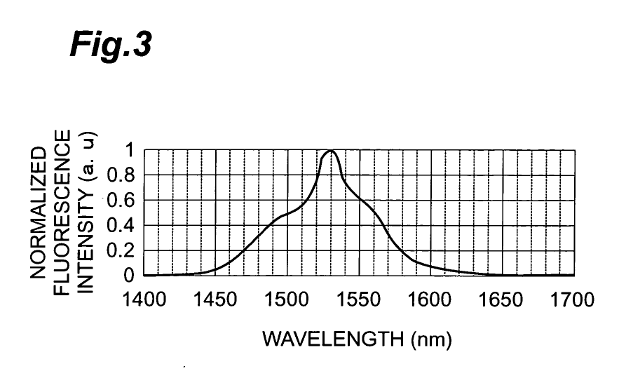

Among the above samples A to D, each of samples A to C was vitrifiable, but sample D as a comparative example was not vitrifiable. Each of the fluorescent glasses of sample A to C was irradiated with pumping light of the wavelength of 980 nm capable of exciting Er ions, and the intensity of fluorescence was measured at wavelength intervals of 1 nm. FIG. 1 is a fluorescence spectrum of the fluorescent glass of sample A. FIG. 2 is a fluorescence spectrum of the fluorescent glass of sample B. FIG. 3 is a fluorescence spectrum of the fluorescent glass of sample C. In these FIGS. 1 to 3, the vertical axis represents the fluorescence intensity normalized by a peak value. As apparent from these FIGS. 1 to 3, each of the fluorescent glasses of samples A to C can generate the fluorescence in a wide wavelength band including the C-band.

### Optical Amplification Waveguide

An embodiment of the optical amplification waveguide according to the present invention will be described below. The optical amplification waveguide according to the present invention has a core region having at least a part made of the fluorescent glass having the structure as described above. In the core region capable of guiding pumping light and signal light, this optical amplification waveguide can amplify the signal light as the pumping light is supplied into the core region. Where the fluorescent glass is applied as an optical amplification medium, the fluorescent glass may be used in bulk, but use thereof in the form of an optical waveguide enables achievement of further compactification and higher efficiency of the optical amplification waveguide. The form of the optical waveguide may be any form of the planar optical waveguide structure, the ridge type structure, and the optical fiber type structure.

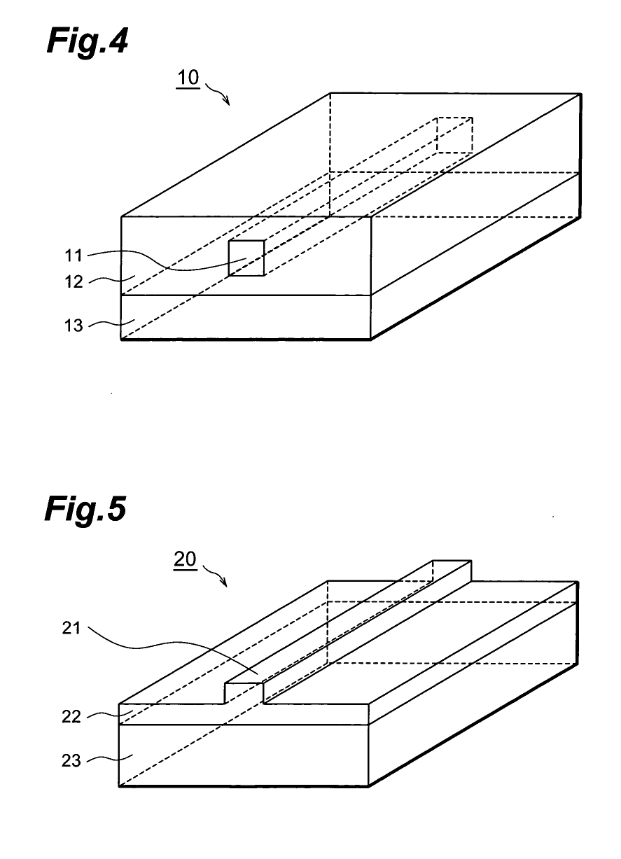

FIG. 4 is a perspective view showing the structure of the first embodiment of the optical amplification waveguide according to the present invention. The optical amplification waveguide 10 in the first embodiment shown in this FIG. 4 has the planar optical waveguide structure, and has a substrate 13, a cladding region 12 formed on the substrate 13, and a core region 11 buried in the cladding region 12. The core region 11 has a rectangular sectional shape uniform along the longitudinal direction thereof, and has a refractive index higher than that of the cladding region 12. At least a part of this core region 11 is made of the fluorescent glass having the structure as described above.

FIG. 5 is a perspective view showing the structure of the second embodiment of the optical amplification waveguide according to the present invention. The optical amplification waveguide 20 according to the second embodiment shown in this FIG. 5 has the ridge type structure and has a substrate 23 and a thin film 22 formed on the substrate 23. A thicker part of the thin film functions as a core region 21. The core region 21 has a sectional shape uniform along the longitudinal direction thereof and has a refractive index higher than that of the substrate 23. At least a part of this core region 21 is made of the fluorescent glass having the structure as described above.

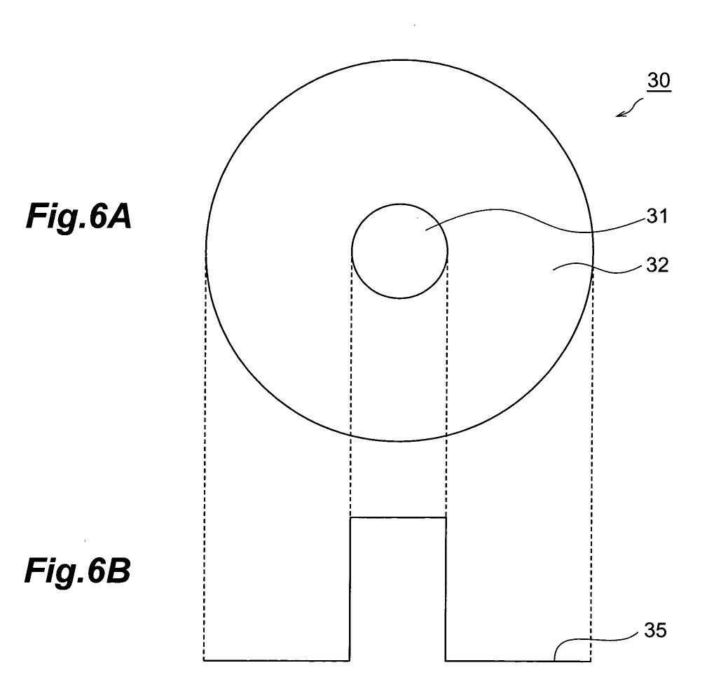

FIGS. 6A and 6B are a sectional view showing the structure of the third embodiment of the optical amplification waveguide according to the present invention, and a refractive index profile thereof. FIG. 6A shows a cross section normal to the optical axis, and FIG. 6B refractive indices of respective portions along the radial direction on the cross section of FIG. 6A. The optical amplification waveguide 30 according to the third embodiment shown in this FIG. 6A has the optical fiber form and has a core region 31 extending along the optical axis, and a cladding region 32 provided on the outer periphery of the core region. The core region 31 has a circular sectional shape uniform along the longitudinal direction thereof and has a refractive index higher than that of the cladding region 32 as shown in the refractive index profile 35 of FIG. 6B. At least a part of this core region 31 is made of the fluorescent glass of the structure as described above.

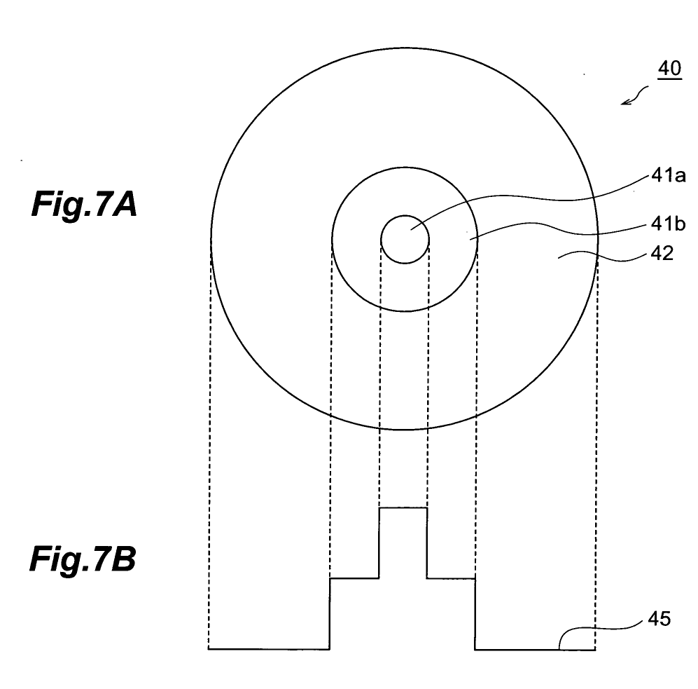

FIGS. 7A and 7B are a sectional view showing the structure of the fourth embodiment of the optical amplification waveguide according to the present invention, and a refractive index profile thereof. FIG. 7A shows a cross section normal to the optical axis, and FIG. 7B shows refractive indices of respective portions along the radial direction on the cross section of FIG. 7A. The optical amplification waveguide 40 according to the fourth embodiment shown in this FIG. 7A has the optical fiber form and has an inner core 41a, an outer core 41b provided on the outer periphery of the inner core 41a, and a cladding region 42 provided on the outer periphery of the outer core 41b. The inner core 41a has a circular sectional shape uniform along the longitudinal direction thereof and has a refractive index higher than that of the cladding region 42 as shown in the refractive index profile 45 of FIG. 7B. At least a part of the inner core 41a is made of the fluorescent glass of the structure as described above. The outer core 41b also has a circular sectional shape uniform along the longitudinal direction thereof and has a refractive index higher than that of the cladding region 42 as shown in the refractive index profile 45 of FIG. 7B. This outer core 41b contains a silica-based glass as a principal component and preferably contains at least one of Al₂O₃, GeO₂, P₂O₅, Cl, and F. In the refractive index profile 45 of the fourth embodiment the refractive index of the inner core 41a is set higher than that of the outer core 41b, but the levels of the refractive indices in these inner core 41a and outer core 41b can be optionally set.

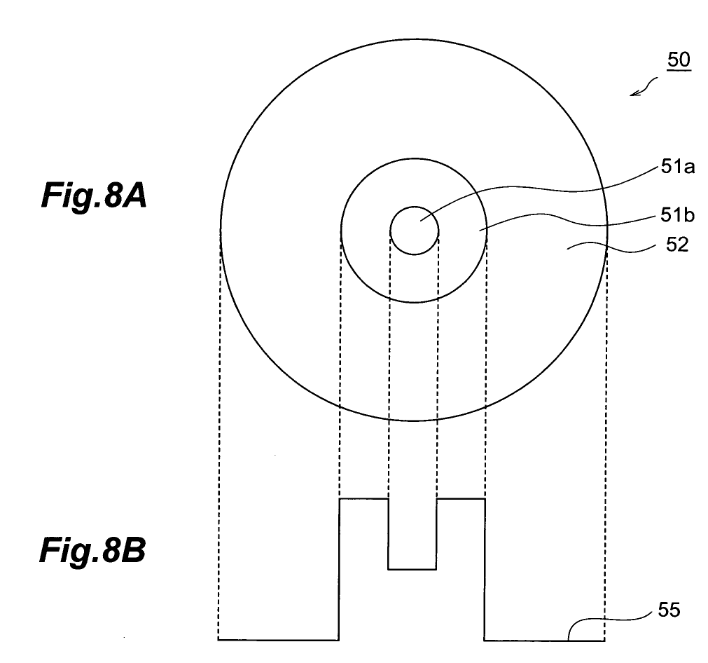

FIGS. 8A and 8B are a sectional view showing the configuration of the fifth embodiment of the optical amplification waveguide according to the present invention, and a refractive index profile thereof. FIG. 8A shows a cross section normal to the optical axis and FIG. 8B refractive indices of respective portions along the radial direction on the cross section of FIG. 8A. The optical amplification waveguide 50 according to the fifth embodiment shown in this FIG. 8A has the optical fiber form and has an inner core 51a, an outer core 51b provided on the outer periphery of the inner core 51a, and a cladding region 52 provided on the outer periphery of the outer core 51b. The inner core 51a has a circular sectional shape uniform along the longitudinal direction thereof and has a refractive index higher than that of the cladding region 52 as shown in the refractive index profile 55 shown in FIG. 8B. This inner core 51a contains a silica-based glass as a principal component and preferably contains at least one of Al₂O₃, GeO₂, P₂O₅, Cl, and F. The outer core 51b also has a circular sectional shape uniform along the longitudinal direction thereof and has a refractive index higher than that of the cladding region 52 as shown in the refractive index profile 55 of FIG. 8B. At least a part of this outer core 51b is made of the fluorescent glass having the structure as described above. Just as in the fourth embodiment described above, the levels of the refractive indices in the inner core 51a and the outer core 51b can be optionally determined.

In the optical amplification waveguide according to the present invention, the cladding region needs to have the refractive index lower than that of the core region and preferably has high transparency. The cladding region may contain a silica-based glass as a principal component or another oxide glass as a principal component. Furthermore, the cladding region may be another material except for glass, e.g., transparent resin. The melting point of the cladding region is preferably 1400° C. or more and, in this case, fusion splicing is facilitated between the optical amplification waveguide according to the present invention and another optical waveguide.

The cladding region (particularly, a portion near the core region) is preferably provided with a number of holes with the diameter of about several hundred nanometers extending in the longitudinal direction thereof. This configuration provides significant effect of confining guided light in the core region and thus increases optical amplification efficiency, whereby the waveguide length can be shortened. In addition, this configuration can curb mode conversion in the optical amplification waveguide even in the waveguide structure permitting propagation in multiple (two or more) modes, thereby enabling propagation substantially in a single mode.

In the optical amplification waveguide, in order to stabilize the amplification operation of signal light induced by supply of pumping light, it is preferable that the cutoff wavelength be shorter than the wavelength of the pumping light under operating conditions of the optical amplification waveguide, i.e., that the pumping light and signal light propagate substantially in the single mode under the operating conditions. Even in the case of the waveguide structure permitting propagation in multiple modes, it also becomes feasible for the guided light to propagate substantially in the single mode, by suppressing the mode conversion in the optical amplification waveguide. In this case, even where the optical amplification waveguide is of a so-called multi-mode fiber structure or in a bulk glass state, these conditions can be met under the operating conditions of the optical amplification waveguide when the waveguide has the length of 10 mm or less and approximately several mm.

In the fluorescent glass or the optical amplification waveguide doped with Er ions as the rare earth ion, the wavelength band of the pumping light capable of pumping the Er ions is the 0.98 μm wavelength band or the 1.48 μm wavelength band. Particularly, the fluorescent glass according to the present invention demonstrates larger absorption of the pumping light in the 1.48 μm wavelength band than the conventional Er ion-doped silica-based glasses, and, in order to increase the pumping efficiency more, it is thus effective to utilize the pumping light in the 1.46 μm wavelength band shorter than the 1.48 μm wavelength band.

In the fluorescent glass or the optical amplification waveguide according to the present invention, it is preferable to optically couple a light input/output end thereof to another optical waveguide (e.g., a silica-based optical fiber). Where the fluorescent glass has a relatively high melting point and has the planar optical waveguide or optical fiber form, it can also be fusion-spliced with another optical waveguide. The fluorescent glass or the optical amplification waveguide in such form can be readily positioned at any place of the preceding stage, the middle, and the subsequent stage of an optical transmission path generally used in optical communication, so as to enable optical amplification of signal light.

Since the fluorescent glass or the optical amplification waveguide according to the present invention also has the large intensity of fluorescence in the S-band (1460 nm to 1530 nm), it can also amplify the signal light in this wavelength band. Of course, the fluorescent glass can also amplify the C-band or L-band signal light. Therefore, the fluorescent glass or the optical amplification waveguide can collectively amplify the signal light of multiple channels (WDM signal light with a plurality of channels multiplexed) across the three S-, C-, and L-bands and, for example, can also be suitably utilized in CWDM (Coarse Wavelength Division Multiplexing) optical communication with wide signal channel spacing.

Specific examples of the optical amplification waveguide having the optical fiber form will be described below in particular out of the optical amplification waveguides according to the present invention.

An optical amplification waveguide a according to Specific Example 1 has the structure similar to the optical fiber 30 shown in FIGS. 6A and 6B and the core region 31 thereof is made of the fluorescent glass of sample A. Specifically, a preform of cylindrical shape-made of the fluorescent glass of sample A is prepared, and this preform is fused and drawn to obtain a glass fiber with the outside diameter of 50 μm. An ultraviolet-curing resin with a refractive index lower than that of the fluorescent glass of sample A is applied and cured on the periphery of the glass fiber made of the fluorescent glass of sample A, to form a resin layer with the outside diameter of 250 μm. In this optical amplification waveguide a in Specific Example 1, the glass fiber made of the fluorescent glass of sample A corresponds to the core region 31, and the resin around it to the cladding region 32.

An optical amplification waveguide b according to Specific Example 2 has the structure similar to the optical fiber 40 shown in FIGS. 7A and 7B, and the inner core 41a thereof is made of the fluorescent glass B of sample B described above. Specifically, the optical amplification waveguide b has the inner core 41a made of the fluorescent glass of sample B, the outer core 41b made of a silica-based glass containing Al₂O₃ of 12 mol %, the cladding region 42 with the outside diameter of 125 μm made of a pure silica glass, and a resin coating layer with the outside diameter of 240 μm formed as a protective layer on the outer periphery of the cladding region 42.

An optical amplification waveguide c according to Specific Example 3 has the structure similar to the optical fiber 50 shown in FIGS. 8A and 8B and the outer core 51b thereof is made of the fluorescent glass C of sample C described above. Specifically, the optical amplification waveguide c has the inner core 51a made of a silica-based glass containing P₂O₅ of 5 mol % and F of 1 mol %, the outer core 51b made of the fluorescent glass of sample C, the cladding region 52 with the outside diameter of 125 μm made of an F-doped silica glass, and a resin coating layer with the outside diameter of 260 μm formed as a protective layer on the outer periphery of the cladding region 52.

The optical amplification waveguides a to c according to the specific examples 1 to 3 in the structures as described above, all can collectively amplify the signal light of multiple channels across the three S-, C-, and L-bands under supply of the 0.98 μm wavelength band or 1.46 μm wavelength band pumping light.

The refractive index profiles 35, 45, 55 shown in FIG. 6B, FIG. 7B, and FIG. 8B, respectively, are schematically depicted as step-shaped refractive index profiles, but there in practice are also cases where the refractive indices continuously vary in the vicinity of the border between glass regions because of thermal diffusion of additives during production.

Taking into account optical coupling with an optical fiber generally used in optical communication, the optical amplification waveguide according to the present invention (particularly, the optical amplification waveguide having the optical fiber form) is preferably configured so that the cladding region has the outside diameter of 100 to 150 μm or 80 to 90 μm. The resin layer provided on the outer periphery of the cladding region preferably has the outside diameter of 220 to 270 μm.

### Optical Amplification Module

An embodiment of the optical amplification module according to the present invention will be described below.

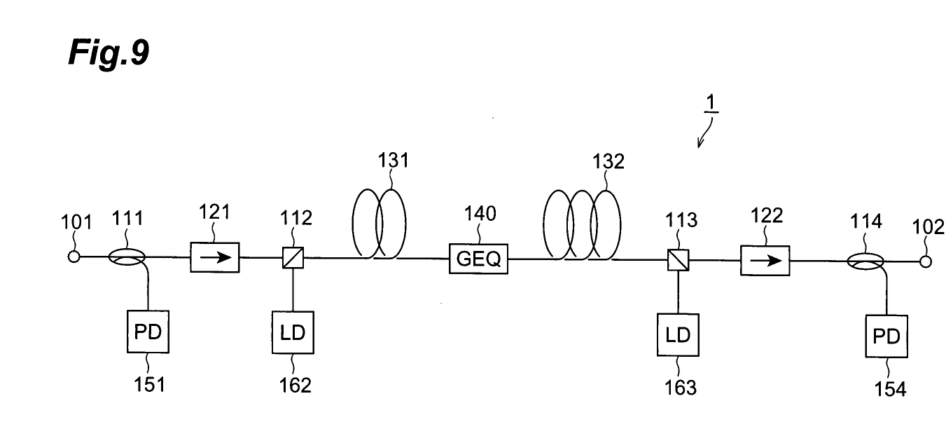

FIG. 9 is an illustration showing a configuration of an embodiment of the optical amplification module according to the present invention, and the optical amplification module 1 incorporates an optical amplification fiber (optical amplification waveguide) made of the fluorescent glass having the structure as described above. Namely, the optical amplification module 1 shown in FIG. 9 amplifies signal light injected through light input end 101 and outputs the amplified signal light through light output end 102 to the outside of the module 1. Specifically, the optical amplification module 1 has an optical coupler 111, an optical isolator 121, an optical coupler 112, an optical amplification fiber 131, a gain equalizer 140, an optical amplification fiber 132, an optical coupler 113, an optical isolator 122, and an optical coupler 114 which are placed in order on a signal light propagation path extending from light input end 101 to light output end 102. The optical amplification module 1 also has a photodiode 151 coupled to the optical coupler 111, a laser diode 162 coupled to the optical coupler 112, a laser diode 163 coupled to the optical coupler 113, and a photodiode 154 coupled to the optical coupler 114.

Each of the optical amplification fibers 131, 132 is configured so that at least a part of the core region thereof is made of the fluorescent glass having the structure as described above (the fluorescent glass according to the present invention), and it guides pumping light and signal light in the core region, and can amplify the signal light under supply of the pumping light. Compositions of the fluorescent glasses forming at least a part of the core region in the respective optical amplification fibers 131, 132 are preferably different from each other, and these optical amplification fibers 131, 132 are optically cascaded on the signal light propagation path. Each of the optical isolators 121, 122 permits light to pass in the forward direction from the light input end 101 to the light output end 102, but does not allow light to pass in the backward direction. The optical coupler 112 and laser diode 162 constitute part of a pumping light supply system for supplying pumping light into the optical amplification fiber 131. The optical coupler 113 and laser diode 163 constitute part of a pumping light supply system for supplying pumping light into the optical amplification fiber 132. The gain equalizer 140 has a loss spectrum of substantially the same shape as gain spectra of these optical amplification fibers 131, 132 in the gain bands of the optical amplification fibers 131, 132, and functions so as to equalize the gains of the optical amplification fibers 131, 132.

In the optical amplification module 1, the pumping light emitted from the laser diode 162 as a pumping light source is supplied through the optical coupler 112 and in the forward direction into the optical amplification fiber 131 (forward pumping). The pumping light emitted from the laser diode 163 as a pumping light source is supplied through the optical coupler 113 and in the backward direction into the optical amplification fiber 132 (backward pumping). The signal light injected through light input end 101 travels via optical coupler 111, optical isolator 121, and optical coupler 112 and reaches the optical amplification fiber 131 to be amplified in this optical amplification fiber 131. The signal light amplified in the optical amplification fiber 131 suffers losses of respective wavelength components in the signal light at the gain equalizer 140 and thereafter the signal light reaches the optical amplification fiber 132. The signal light having passed the gain equalizer 140 is then amplified in this optical amplification fiber 132. The signal light amplified in the optical amplification fiber 132 further travels via optical coupler 113, optical isolator 122, and optical coupler 114 and is then outputted through light output end 102 to the outside of the optical amplification module 1. On the other hand, part of the signal light injected through the light input end 101 is separated by optical coupler 111 and the power thereof is monitored by photodiode 151. Likewise, part of the signal light having passed the optical isolator 122 and traveling toward the light output end 102 is also separated by optical coupler 114 and the power thereof is monitored by the photodiode 154.

A gain spectrum of the entire optical amplification module 1 is a total spectrum of the gain spectrum of the optical amplification fiber 131, the gain spectrum of the optical amplification fiber 132, and the loss spectrum of the gain equalizer 140. Since the fluorescent glasses forming at least a part of the core region in the respective optical amplification fibers 131, 132 have their respective compositions different from each other, the gain bands of the respective optical amplification fibers 131, 132 are different from each other and thus the optical amplification module 1 can have the gain over a wide band as a whole. Since each of the optical amplification fibers 131, 132 has the structure similar to one of the optical amplification waveguides in the third to fifth embodiments of the aforementioned structures (the optical fiber form), it can have the desired gain over the wide band in this respect, too.

The optical amplification module 1 shown in FIG. 9 is constructed using the optical amplification waveguides of the optical fiber form (the optical amplification waveguides according to the third to fifth embodiments) as optical amplification media, but the fluorescent glass according to the present invention may also be used as optical amplification media. The optical amplification module 1 of FIG. 9 (the optical amplification module according to the present invention) to which the fluorescent glass or the optical amplification waveguide according to the present invention was applied, was the optical amplifier for amplifying the signal light, but the fluorescent glass or the optical amplification waveguide according to the present invention can also be suitably applied as an optical amplification medium in laser oscillation apparatus.

As described above, the fluorescent glass according to the present invention comprises Al₂O₃ of 15 to 50 mol %; SiO₂ of 0 to 80 mol %; an oxide of 5 to 85 mol % in total comprising at least one of B₂O₃, Ga₂O₃, Y₂O₃, Ta₂O₅, Sb₂O₃, Nd₂O₅, La₂O₃, and Yb₂O₃; and a rare earth ion. In this configuration, concentration quenching is more suppressed in the fluorescent glass than in the conventional fluorescent glasses, and thus the fluorescent glass can be doped with a high concentration of rare earth ions and highly efficiently generate the fluorescence of wavelengths in the signal wavelength bands generally used in optical communication.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. A fluorescent glass comprising:
Al₂O₃ of 15 to 50 mol %;
SiO₂ of 0 to 80 mol %;
an oxide of 5 to 85 mol % in total comprising at least one of B₂O₃, Ga₂O₃, Y₂O₃, Ta₂O₅, Sb₂O₃, Nd₂O₅, La₂O₃, and Yb₂O₃; and
a rare earth ion.

2. A fluorescent glass according to claim 1, wherein said oxide comprises B₂O₃ of 5 to 85 mol %.

3. A fluorescent glass according to claim 1, wherein said oxide comprises at least one oxide of 5 to 85 mol % in total selected from Ga₂O₃, Y₂O₃, Ta₂O₅, Sb₂O₃, Nd₂O₅, La₂O₃, and Yb₂O₃, except said B₂O₃.

4. A fluorescent glass according to claim 1, wherein said rare earth ion comprises an Er ion in a weight proportion of 2000 wt.ppm or more.

5. An optical amplification waveguide amplifying signal light under supply of pumping light, comprising:
a core region which extends along a predetermined axis and through which the signal light and pumping light propagates, at least a part of said core region comprised of a fluorescent glass according to claim 1; and
a cladding region provided on an outer periphery of said core region.

6. An optical amplification waveguide according to claim 5, wherein said core region comprises an inner core comprised of said fluorescent glass; and an outer core provided on an outer periphery of said inner core and comprised of a silica-based glass as a principal component.

7. An optical amplification waveguide according to claim 6, wherein said outer core comprises at least one of Al₂O₃, GeO₂, P₂O₅, Cl, and F.

8. An optical amplification waveguide according to claim 5, wherein said core region comprises an inner core comprised of a silica-based glass as a principal component; and an outer core provided on an outer periphery of said inner core and comprised of said fluorescent glass.

9. An optical amplification waveguide according to claim 8, wherein said inner core contains at least one of Al₂O₃, GeO₂, P₂O₅, Cl, and F.

10. An optical amplification waveguide according to claim 5, wherein said cladding region, provided on the outer periphery said core region, has a refractive index lower than that of said core region and has a melting point of 1400° C. or more.

11. An optical amplification module comprising:
an optical transmission medium having at least a part comprised of a fluorescent glass according to claim 1; and
a pumping light supply system for supplying pumping light into said optical transmission medium.

12. An optical amplification module comprising:
an optical amplification waveguide according to claim 5; and
a pumping light supply system for supplying pumping light into said optical amplification waveguide.
